(19) United States
(12) Patent Application Publication
(10) Pub. No.: US 2019/0384123 A1
(43) Pub. Date: Dec. 19, 2019

(54) DISPLAY PANEL AND METHOD OF MANUFACTURING DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventor: Xuanyun WANG, Wuhan, Hubei (CN)

(21) Appl. No.: 15/735,900

(22) PCT Filed: Nov. 23, 2017
(86) PCT No.: PCT/CN2017/112575

§ 371 Date: Dec. 12, 2017

(30) Foreign Application Priority Data
Oct. 19, 2017 (CN) 201710992120.8

(51) Int. Cl. G02F 1/1343; G02F 1/1335

(52) U.S. Cl. CPC G02F 1/134309; G02F 2001/134381; G02F 1/133514

(57) ABSTRACT

The disclosure discloses a display panel and a method for manufacturing a display panel. The display panel includes an array substrate, a color film substrate and a liquid crystal layer located between the array substrate and the color film substrate. The array substrate includes a first substrate, a first common electrode and a pixel electrode. The color film substrate includes a second common electrode. During a fall time of the panel transferred from a bright state to a dark state, the first common electrode and the second common electrode are energized the pixel electrode is not energized and the liquid crystal is subjected to a vertical electric field to rapidly return to an initial vertical orientation state, thereby speeding up a response time of the display panel and eliminate the image lag.

### RELATED APPLICATIONS

The present application is a National Phase of International Application Number PCT/CN2017/112575, filed Nov. 23, 2017, and claims the priority of China Application No. 201710992120.8, filed Oct. 19, 2017.

### FIELD OF THE DISCLOSURE

The disclosure relates to a display technical field, and more particularly to a display panel and a method of manufacturing the display panel.

### BACKGROUND

As a result of the rotation of the liquid crystal molecules, each sub-pixel on the liquid crystal display (LCD) screen transferred from the previous frame color brightness to the next frame color has a time course, that is, a well-known response time.

The response time is an important parameter to measure the level of liquid crystal display performance. The shorter the response time, the less the silhouette drag phenomenon when the user sees a dynamic picture, and the user may have a better visual experience.

Now as regarding to the definition of response time, “black→+white→+black” (bright→dark→bright) full response time is taken as a standard basically. The response time includes a rise time and a fall time. The rise time refers to a time of the panel transferred from dark state to bright state, and it mainly determined by the rotation speed under the liquid crystal is subjected to the electric field. The fall time refers to a time of the panel transferred from bright state to dark state, and it mainly determined by the speed of the liquid crystal transferred back to the original orientation location under the liquid crystal is subjected to the anchoring force of a liquid crystal orientation. When the liquid crystal has a high viscosity or is in a low temperature environment, the fall time of the liquid crystal may become slow, it becomes a main reason for the slower response time, and the slower response time may cause the image lag.

### SUMMARY

A technical problem to be solved by the disclosure is to provide a display panel and a method of manufacturing the display panel to speed up the response time and eliminate the image lag.

In order to solve the above technical problems, a technical solution adopted by the disclosure is as follows.

A display panel is provided, wherein the display panel includes:

an array substrate and a color film substrate disposed opposite to each other, and a liquid crystal layer located between the array substrate and the color film substrate;

the array substrate including a first substrate, a first common electrode, an insulating layer and a pixel electrode, the first common electrode being located between the first substrate and the insulating layer, and the pixel electrode being located on the insulating layer and toward the color film substrate;

the color film substrate including a second common electrode and a second substrate, and the second common electrode being on the second substrate and toward the array substrate; and

during a fall time of the panel from a bright state to a dark state, the first common electrode and the second common electrode being energized, the pixel electrode being not energized and the liquid crystal being subjected to a vertical electric field to return to an initial vertical orientation state.

Another technical solution adopted by the disclosure is as follows.

A display panel is provided, wherein the display panel includes:

an array substrate and a color film substrate disposed opposite to each other, and a liquid crystal layer located between the array substrate and the color film substrate;

the array substrate including a first common electrode (Com-1) and a pixel electrode, the color film substrate including a second common electrode (Com-2); and

during a fall time of the panel transferred from a bright state to a dark state, the first common electrode and the second common electrode being energized, the pixel electrode being not energized and the liquid crystal being subjected to a vertical electric field to return to an initial vertical orientation state.

Another technical solution adopted by the disclosure is as follows.

A method of manufacturing a display panel is provided, and the method includes:

arranging an array substrate including a first common electrode and a pixel electrode;

arranging a color film substrate including a second common electrode opposite to the array substrate;

arranging a liquid crystal layer between the array substrate and the color film substrate;

energizing the first common electrode and the second common electrode and not energizing the pixel electrode, such that the liquid crystal is subjected to a vertical electric field to return to an initial vertical orientation state during a fall time of the panel transferred from a bright state to a dark state.

The advantageous effect of the disclosure is that: different from the prior art, in the disclosure, the second common electrode is arranged on the color film substrate of the display panel, the first common electrode and the second common electrode are energized, the pixel electrode is not energized, and the liquid crystal is subjected to the vertical electric filed to rapidly return to the initial vertical orientation state, such that the fall time of the panel transferred from the bright state to the dark state is speeded up, thereby improving the response time of the display panel and eliminating the image lag.

### BRIEF DESCRIPTION OF THE DRAWINGS

In order to illustrate the embodiments of the disclosure or the technical scheme in the prior art more clearly, the following drawings used in the description of the embodiments or the prior art, will be briefly described. It will be apparent that the drawings in the following description are only embodiments of the disclosure, other drawings can be obtained by a person skilled in the art in accordance with the drawings provided, without paying any creative work.

FIG. 1 is a structural schematic view of a display panel according to the disclosure;

FIG. 2 is a schematic view of a state of the display panel at a rise time according to the disclosure;

FIG. 3 is a schematic view of a state of the display panel at a fall time according to the disclosure;

FIG. 4 is a flow chart of a method of manufacturing the display panel according to the disclosure.

### DETAILED DESCRIPTION OF PREFERRED EMBODIMENTS

The technical scheme in the embodiments of the disclosure will now be described clearly and fully in conjunction with the accompanying drawings in the embodiments of the disclosure, and it will be apparent that the described embodiments are merely a part of the embodiments of the disclosure and are not all of the embodiments. Based on embodiments in the disclosure, all other embodiments obtained by a person skilled in the art without paying any creative work are within the protection scope of the disclosure.

Refer to FIG. 1, FIG. 1 is a structural schematic view of a display panel according to the disclosure. The display panel includes:

an array substrate 10 and a color film substrate 20 arranged opposite to each other; and

a liquid crystal layer 30 located between the array substrate 10 and the color film substrate 20.

The array substrate 10 includes a first substrate 11 and a first common electrode 12, an insulating layer 13, and a pixel electrode 14 located on the first substrate 11, and the pixel electrode 14 is arranged toward the color film substrate 20.

The color film substrate 20 includes a second substrate 21 and a second common electrode 22 located on the second substrate 21, and the second common electrode 22 is arranged toward the array substrate 10.

In the array substrate 10, the first substrate 11 is a transparent glass substrate.

In the array substrate 10, the first common electrode 12 and the pixel electrode 14 are transparent ITO (Indium Tin Oxides) electrodes.

In the array substrate 10, the insulating layer 13 is silicon nitride (SiNx).

In the color film substrate 20, the second substrate 21 is a transparent glass substrate.

In the color film substrate 20, the second common electrode 22 is a transparent ITO electrode.

In the liquid crystal layer 30, the liquid crystal molecules are negative liquid crystals, and the original orientation of the liquid crystal molecules between the array substrate 10 and the color film substrate 20 represents a vertical orientation state.

In the non-energized state, there is no electric field between the first substrate 11 and the second substrate 21, and the liquid crystal molecules in the liquid crystal layer 30 represent vertical orientation state, and the panel is in a dark state.

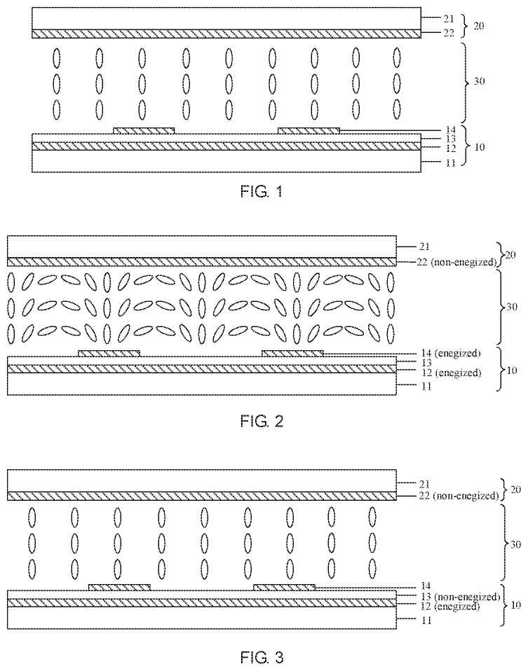

Refer to FIG. 2, FIG. 2 is a schematic view of a state of the display panel at the rise time according to the disclosure.

The pixel electrode 14 and the first common electrode 12 are energized, the second common electrode 22 is not energized, the liquid crystal is subjected to a horizontal electric field and gradually tended to a horizontal rotation, and the panel is transferred from the dark state to the bright state, and this process is the rise time.

Refer to FIG. 3, FIG. 3 is a schematic view of a state of the display panel at a fall time according to the disclosure.

The first common electrode 12 and the second common electrode 22 are energized, the pixel electrode 14 is not energized, the liquid crystal is subjected to a vertical electric field to rapidly return to an initial vertical orientation state, and the panel is transferred from the bright state to the dark state, and this process is the fall time.

Since the electric field force in the vertical direction forces the liquid crystal to transfer back to the initial orientation direction, the fall time of the liquid crystal is much faster, and the overall response time of the display panel is improved. Even if in the extreme low temperature environment, the display panel may maintain a fast response time and does not appear the image lag.

In the embodiment, the display panel is an edge field switch display panel.

In the embodiment, the display panel only shows a partial structure, and the other structure of the display panel is the same as that of the existing display panel, for example, the display panel may further include other film layers such as polarizers, etc., and the description thereof is omitted.

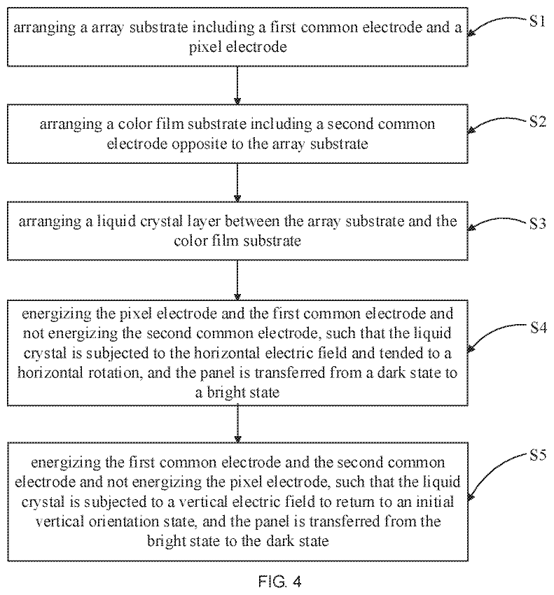

Refer to FIG. 4, FIG. 4 is a flow chart of a method of manufacturing the display panel according to the disclosure. The method of manufacturing the display panel includes the following steps.

Step S1: arranging an array substrate 10 including a first common electrode 12 and a pixel electrode 14.

The first common electrode 12 and the pixel electrode 14 are transparent ITO electrodes.

Step S2: arranging a color film substrate 20 including a second common electrode 22 opposite to the array substrate 10.

The second common electrode 22 is a transparent ITO electrode.

Step S3: arranging a liquid crystal layer 30 between the array substrate 10 and the color film substrate 20.

The liquid crystal molecules in the liquid crystal layer 30 are negative liquid crystals, and the original orientation between the array substrate 10 and the color film substrate 20 represents vertical orientation state, and at this time, the panel is in a dark state.

Step S4: energizing the pixel electrode 14 and the first common electrode 12 and not energizing the second common electrode 22, such that the liquid crystal is subjected to the horizontal electric field and tended to a horizontal rotation, and the panel is transferred from a dark state to a bright state.

Step S5: energizing the first common electrode 12 and the second common electrode 22 and not energizing the pixel electrode 14, such that the liquid crystal is subjected to a vertical electric field to return to an initial vertical orientation state, and the panel is transferred from the bright state to the dark state.

Wherein the array substrate 10 in the step S1 further includes a first substrate 11 and an insulating layer 13, and the first common electrode 12 is arranged between the first substrate 11 and the insulating layer 13, and the pixel electrode 14 is arranged on the insulating layer 13 and toward the color film substrate 20.

The first substrate 11 is a transparent glass substrate.

The insulating layer 13 is silicon nitride.

Wherein the color film substrate 20 in the step S2 further includes a second substrate 21, and the second common electrode 22 is arranged on the second substrate 21 and toward the array substrate 10.

The second substrate 21 is a transparent glass substrate.

In the embodiment, a projection of the second common electrode 22 on the array substrate 10 completely overlaps with the first common electrode 12.

In the embodiment, the display panel is an edge field switch display panel.

In the embodiment, the display panel only shows a partial structure, and the other structure of the display panel is the same as that of the conventional display panel, for example, the display panel may include other film layers such as polarizers, and the description thereof is omitted.

According to the display panel and a method of manufacturing a display panel of the disclosure, the first common electrode 12 and a pixel electrode 14 are arranged on the array substrate 10 and the second common electrode 22 are arranged on the color film substrate 20, and during the fall time of the panel transferred from the bright state to the dark state, the common electrode 12 and the second common electrode 22 are energized and the pixel electrode 14 is not energized, such that the liquid crystal is not subjected to the action of the anchoring force and the liquid crystal is transferred back to the initial direction not due to due to the action of the electric field force in the vertical direction, so as to speed up the fall time, improve the response time of the display panel, and eliminate the image lag.

The foregoing embodiments are merely illustrative of the technical scheme of the disclosure and are not intended to be limiting thereof; although the disclosure has been described in detail with reference to the foregoing embodiments, it will be understood by a person skilled in the art that the disclosure may be directed to the foregoing embodiments or the equivalents of some of the technical features therein; and such modifications or substitutions do not depart from the spirit and scope of the technical solutions of the various embodiments of the disclosure without departing from the spirit of the corresponding technical solution.

What is claimed is:

1. A display panel, comprising:
an array substrate and a color film substrate arranged opposite to each other, and a liquid crystal layer located between the array substrate and the color film substrate;
the array substrate comprising a first substrate, a first common electrode, an insulating layer and a pixel electrode, the first common electrode being located between the first substrate and the insulating layer, and the pixel electrode being located on the insulating layer and toward the color film substrate;
the color film substrate comprising a second common electrode and a second substrate, and the second common electrode being on the second substrate and toward the array substrate; and
during a fall time of the panel from a bright state to a dark state, the first common electrode and the second common electrode being energized, the pixel electrode being not energized, and the liquid crystal being subjected to a vertical electric field to return to an initial vertical orientation state.

2. A display panel, comprising:
an array substrate and a color film substrate arranged opposite to each other, and a liquid crystal layer located between the array substrate and the color film substrate;
the array substrate comprising a first common electrode and a pixel electrode, and the color film substrate comprising a second common electrode; and
during a fall time of the panel transferred from a bright state to a dark state, the first common electrode and the second common electrode being energized, the pixel electrode being not energized and the liquid crystal being subjected to a vertical electric field to return to an initial vertical orientation state.

3. The display panel according to claim 2, wherein the array substrate further comprises a first substrate and an insulating layer, the first common electrode is located between the first substrate and the insulating layer, and the pixel electrode is located on the insulating layer and toward the color film substrate.

4. The display panel according to claim 2, wherein the color film substrate further comprises a second substrate, and the second common electrode is located on the second substrate and toward the array substrate.

5. The display panel according to claim 2, wherein a projection of the second common electrode on the array substrate completely overlaps with the first common electrode.

6. The display panel according to claim 2, wherein during a rise time of the panel transferred from the dark state to the bright state, the first common electrode and the pixel electrode are energized, the second common electrode is not energized, and the liquid crystal is subjected to a horizontal electric field and tended to a horizontal rotation.

7. A method of manufacturing a display panel, comprising:
arranging an array substrate comprising a first common electrode and a pixel electrode;
arranging a color film substrate comprising a second common electrode opposite to the array substrate;
arranging a liquid crystal layer between the array substrate and the color film substrate;
energizing the first common electrode and the second common electrode and not energizing the pixel electrode, such that the liquid crystal is subjected to a vertical electric field to return to an initial vertical orientation state during a fall time of the panel transferred from a bright state to a dark state.

8. The method of manufacturing the display panel according to claim 7, wherein the arranging the array substrate comprising the first common electrode and the pixel electrode further comprises: a first substrate and an insulating layer, the first common electrode being arranged between the first substrate and the insulating layer, and the pixel electrode being arranged on the insulating layer and toward the color film substrate.

9. The method of manufacturing the display panel according to claim 7, wherein the arranging the color film substrate comprising the second common electrode opposite to the array substrate further comprises: a second substrate, and the second common electrode being arranged on the second substrate and toward the array substrate.

10. The method of manufacturing the display panel according to claim 7, wherein the projection of the second common electrode on the array substrate completely overlaps with the first common electrode.

11. The method of manufacturing the display panel according to claim 7, wherein before the step of energizing the first common electrode and the second common electrode and not energizing the pixel electrode, such that the liquid crystal is subjected to the action of the vertical electric field to return the an initial vertical orientation state during the fall time of the panel from the bright state to the dark state comprising:
energizing the first common electrode and the pixel electrode and not energizing the second common electrode, such that the liquid crystal is subjected to the horizontal electric field and tended to a horizontal rotation, and the panel is transferred from the dark state to the bright state.
